(19) United States
(12) Patent Application Publication
(10) Pub. No.: US 2017/0018331 A1
(43) Pub. Date: Jan. 19, 2017

(54) MULTI-CORE ELECTRIC POWER METAL CONDUCTIVE WIRE AND METHOD OF MANUFACTURE THEREOF

(71) Applicant: INNOTRANS TECHNOLOGY CO., LTD., Taipei (TW)

(72) Inventor: Jen-Yao HU, Tainan (TW)

(21) Appl. No.: 14/799,928

(22) Filed: Jul. 15, 2015

(51) Int. Cl. H01B 7/30; H01B 1/02; H01B 13/00

(52) U.S. Cl. CPC H01B 7/30; H01B 13/0036; H01B 1/026

(57) ABSTRACT

A multi-core electric power metal conductive wire is manufactured according to the steps as follow: first, providing a plurality of solid conductive cores; next, providing a first conductive metal material with a first DC resistance to encase each conductive core to form a conductive strand; collecting and binding a plurality of conductive strands in one bundle; providing at least one sheet type second conductive metal material to encase the bundle of the conductive strands to form a conductive bus and form a connection seam between two side walls of the second conductive metal material not yet connected; forming an electric connection spot at the connection seam through a welding process; and finally providing an insulation encasing material to encase the conductive bus to finish the multi-core electric power metal conductive wire. The invention provides a simpler fabrication process and can reduce skin effect of the metal conductive wire.

### FIELD OF THE INVENTION

The present invention relates to an electric power metal conductive wire and particularly to a multi-core electric power metal conductive wire and a method of manufacture thereof.

### BACKGROUND OF THE INVENTION

Skin effect is a phenomenon happened to a conductor with AC power or alternating electromagnetic field passing through that has electric current distributed unevenly inside the conductor and converged to the surface of the conductor. It happens this way because when the conductive wire has the AC current passed though the electromotive force in the center of the conductor is greater than that around the surface of the conductor, hence electrons flow only on the surface without passing through the center of the conductor. This makes the electric current distributed unevenly. Such a phenomenon generates eddy current in a direction opposite to the current flowing inside the conductor and offsets a portion of the current flowing in the conductor, and the resistance of the conductor increases with increasing of AC power frequency, as a result electric power transmission efficiency of the conductor decreases.

To overcome the impact of the skin effect many producers try to increase or decrease the diameter of the conductor or employ multiple strands to eliminate the skin effect. For instance, Taiwan patent No. 1270087 discloses a wire core for power or signal transmission line. The wire core has an isometric section and a non-isometric section connected to the isometric section. The non-isometric section has an extended section extended inward to form a surface area greater than that of the isometric section to transmit electric power or signal. While it can eliminate the skin effect, making the non-isometric section requires a complex fabrication process. Moreover, the non-isometric section formed in different types has different physical strength, as a result the wire core cannot withstand compression or bending resulted from external forces, and fracturing could happen. Although the prior technique provides a conductive stranded cable not in a simple circular shape it requires a complex fabrication process and has structural limitation, hence is not widely adopted. There is still room for improvement in terms of resolving the issue of skin effect.

### SUMMARY OF THE INVENTION

The primary object of the present invention is to solve the problem of the conventional electric power metal conductive wire of easily generating skin effect during transmission of AC power or high frequency current that results in decrease of conduction efficiency.

To achieve the foregoing object the present invention provides a multi-core electric power metal conductive wire manufacturing method that comprises the steps as follow:

preparing material step: provide a plurality of solid conductive cores;

first encasing step: provide a first conductive metal material with a first DC resistance to encase each conductive core to form a conductive strand;

binding step: collect and bind a plurality of conductive strands in one bundle;

second encasing step: provide at least one sheet type second conductive metal material to encase the bundle of the conductive strands to form a conductive bus and form a connection seam between two side walls of the second conductive metal material that are not yet connected;

electric connection step: form an electric connection spot at the connection seam to bridge the two side walls of the second conductive metal material that face the connection seam through a welding process; and

insulation encasing step: provide an insulation encasing material to encase the conductive bus to finish the multi-core electric power metal conductive wire.

In one embodiment the insulation encasing step is further preceded by a stretching step to change total length of the conductive bus by stretching via a fabrication process.

In another embodiment the insulation encasing step includes a calendering step to apply a pressure on the conductive bus through a mechanical fabrication process to flatten the conductive bus.

In yet another embodiment the insulation encasing step is followed by a cutting step to cut the conductive bus at a preset length.

In yet another embodiment the insulation encasing step is preceded by a cutting step to cut the conductive bus at a preset length.

In yet another embodiment the first DC resistance of the first conductive metal material is greater than the DC resistance of the conductive core.

In yet another embodiment the binding step binds the conductive strands in a cross-woven fashion through a weaving process.

In yet another embodiment a multi-core electric power metal conductive wire is manufactured through the aforesaid manufacturing method.

Through the manufacturing method and the conductive wire of the invention set forth above, compared with the conventional technique, many advantages can be provided, notably:

1. Different types of metal materials can be encased in an order as desired to form multi-layer conductive layers so that when the multi-core electric power conductive wire is used to transmit high frequency power or AC power electric current can be evenly distributed and flow therein to avoid impact caused by skin effect.

2. The method provided by the invention is simpler and can facilitate mass production.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a flowchart of a first embodiment of the manufacturing method of the invention.

FIGS. 2A through 2D are schematic sectional views showing the structure of the first embodiment of the multi-core electric power metal conductive wire of the invention.

FIG. 3 is a schematic view of the structure of the first embodiment of the multi-core electric power metal conductive wire of the invention.

FIG. 4 is a schematic view of the structure of a second embodiment of the multi-core electric power metal conductive wire of the invention.

FIG. 5 is a flowchart of a third embodiment of the manufacturing method of the invention.

FIG. 6 is a flowchart of a fourth embodiment of the manufacturing method of the invention.

FIG. 7 is a flowchart of a fifth embodiment of the manufacturing method of the invention.

### DETAILED DESCRIPTION OF THE PREFERRED EMBODIMENTS

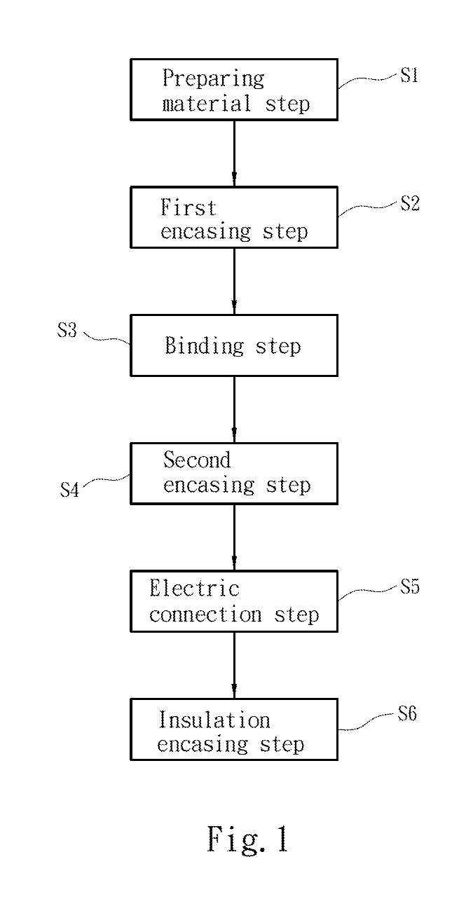

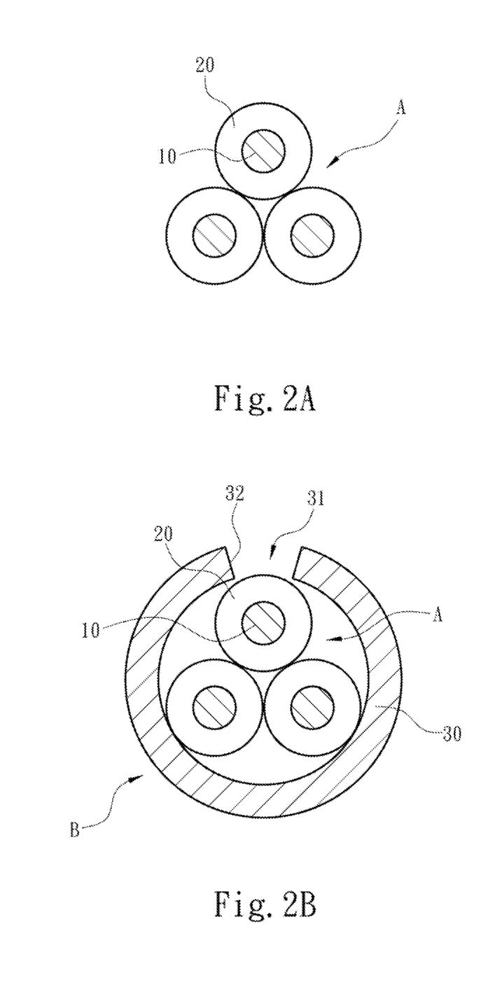

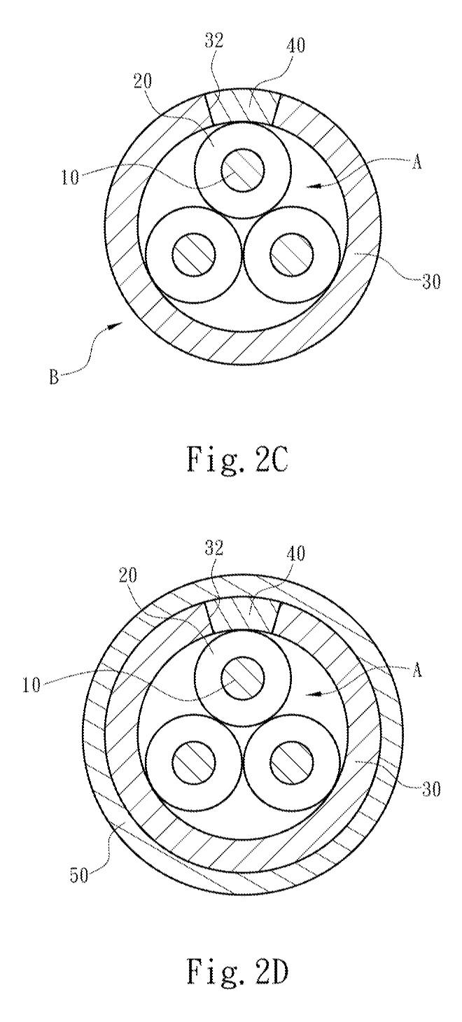

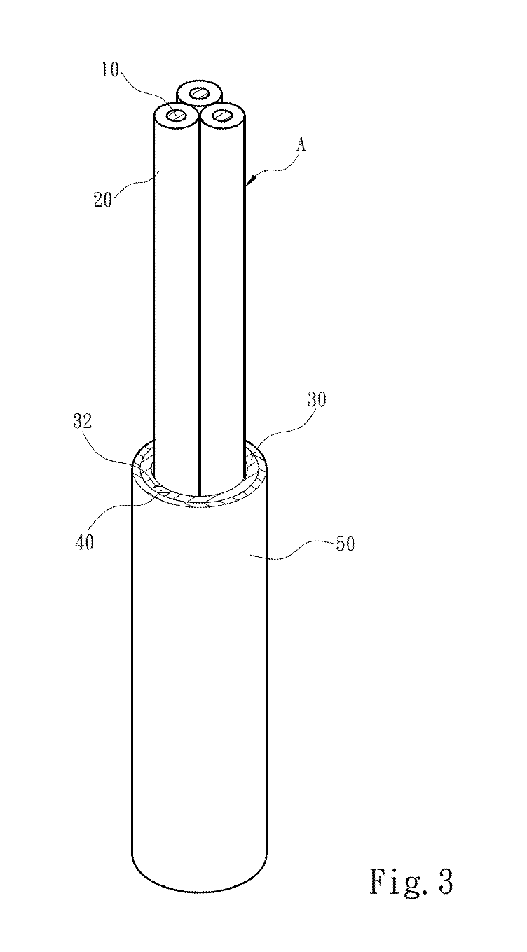

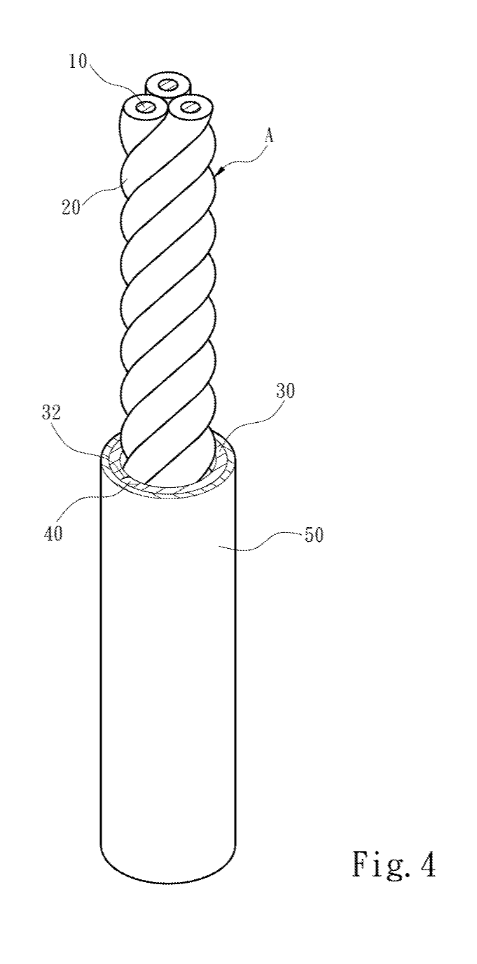

Please referring to FIGS. 1, 2A through 2D, the present invention aims to provide a multi-core electric power metal conductive wire and a method of manufacture thereof. The multi-core electric power metal conductive wire mentioned herein is not the conventional coaxial cable for signal transmission, but mainly for electric power transmission, such as for winding of transformers. To facilitate explanation of the multi-core electric power metal conductive wire the method for manufacturing the multi-core electric power metal conductive wire is discussed first as follow. The method includes: first, a preparing material step S1: provide a plurality of solid conductive cores 10 each can be copper or other metal conductive material with desired conduction coefficient; next, a first encasing step S2: provide a first conductive metal material 20 with a first DC resistance to encase each conductive core 10 to form a conductive strand A. More specifically, the first conductive metal material 20 can be aluminum, tin or zinc. The first DC resistance of the first conductive metal material 20 is higher than the DC resistance of the conductive core 10 in terms of characteristics comparison. Moreover, the first conductive metal material 20 can fully encase the surface of the conductive core 10 through a physical or chemical approach, such as coating, plating or sputtering, to form the conductive strand A. Next, a binding step S3: collect and bind a plurality of conductive strands A in one bundle; the invention takes three conductive strands A as an example for discussion, but this is not the limitation of the invention. In addition, the step S3 also can include weaving the conductive strands A in a cross-woven fashion (as shown in FIGS. 3 and 4) through twisting, mesh weaving or double cross weaving or the like. Next, a second encasing step S4: provide at least one sheet type second conductive metal material 30 which has second DC resistance smaller than the first DC resistance to encase the bundle of the conductive strands A to form a conductive bus B, and also form a connection seam 31 between two side walls 32 of the second conductive metal material 30 that are not yet connected. Furthermore, the second conductive metal material 30 can be selected same as that of the conductive core 10, or a different material to do encasing. The second conductive metal material 30 can be made of copper or other materials with desired conduction coefficient. In addition, the second conductive metal material 30 can be set at a length smaller than the total perimeter of the conductive strands A after being bound into a bundle so that the second conductive metal material 30 does not fully cover the conductive strands A during the encasing process but forms the connection seam 31 at the not encased portion; with the conductive strands A encased by the second conductive metal material 30 the conductive bus B is formed. Next, an electric connection step S5: form an electric connection spot 40 at the connection seam 31 through a welding process to bridge the two side walls 32 of the second conductive metal material 30 that face the connection seam 31. The welding process can be argon welding or heat-submerging tin process or the like to weld a solder on the connection seam 31 to bridge the two side walls 32 and form the electric connection spot 40. However, in practice the welding zone of the second conductive metal material 30 is not limited to the connection seam 31, but can be extended to the surface of the second conductive metal material 30, thereby form electric connection between the second conductive metal material 30 and the electric connection spot 40. Finally, enter an insulation encasing step S6: provide an insulation encasing material 50 to encase the conductive bus B to finish the multi-core electric power metal conductive wire. The insulation encasing material 50 can be implemented via a tube or coating to encase the conductive bus B, and can be selected from the group consisting of epoxy, acrylic resin, silicon resin, polytetrafluoroethylene and polyurethane. After the conductive bus B is fully encased by the insulation encasing material 50, the multi-core electric power metal conductive wire is formed.

Please referring to FIGS. 2A through 2D, by means of the manufacturing method previously discussed, the multi-core electric power metal conductive wire of the invention mainly includes a plurality of conductive strands A that are encased by the conductive bus B which is in turn encased by the insulation encasing material 50. Each conductive strand A consists of the solid conductive core 10 and the first conductive metal material 20 which encases the solid conductive core 10. The conductive bus B consists of a plurality of conductive strands A and the second conductive metal material 30 which encases the conductive strands A. Thus the multi-core electric power metal conductive wire of the invention is formed in a multi-layer conductive layers fashion, and the DC resistance of the first conductive metal material 20 is greater than that of other conductive layers (such as the second conductive metal material 30), therefore when the multi-core electric power metal conductive wire is used for transmission of AC power or high frequency current the high frequency current or low frequency current in the electric power can evenly pass through by conduction without generating skin effect that might otherwise cause drop of conduction efficiency.

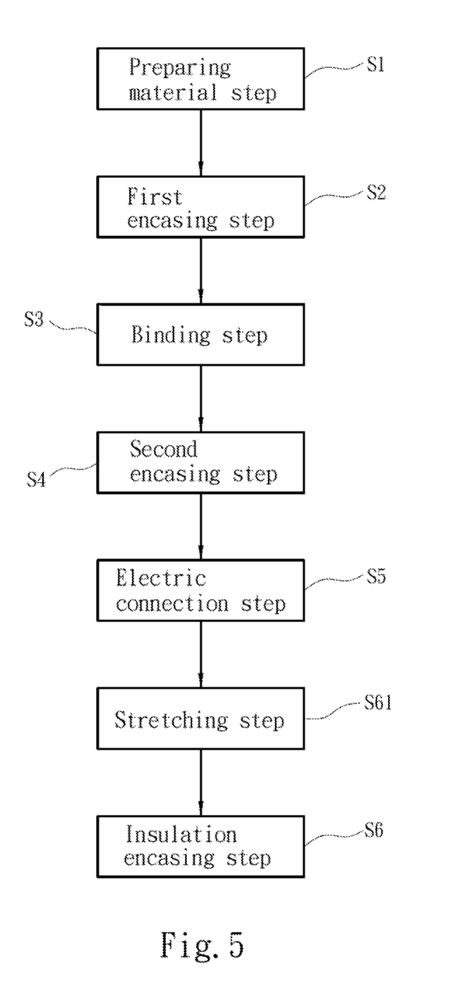

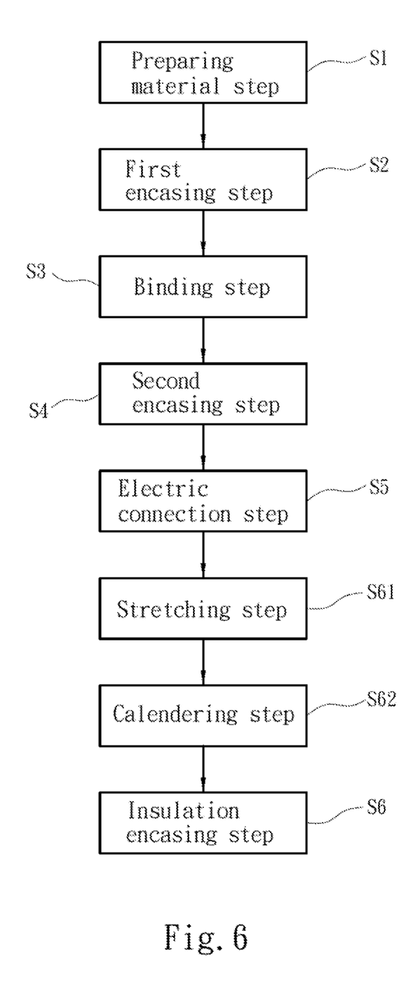

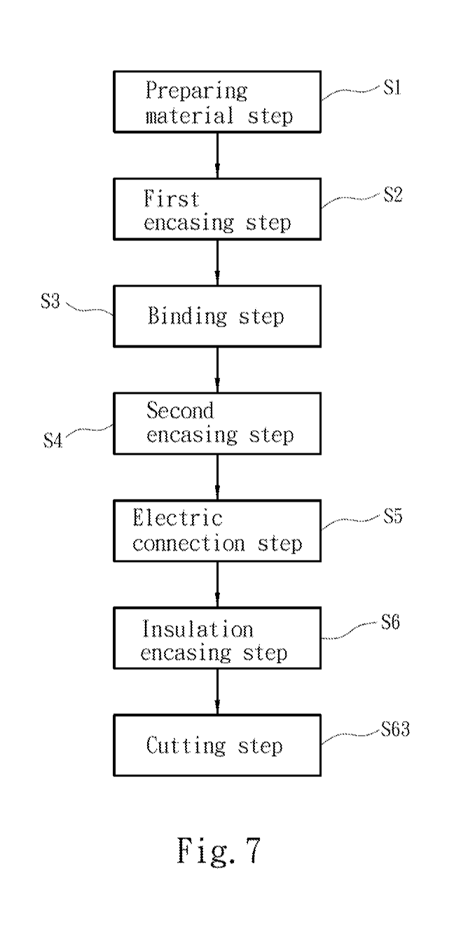

Please referring to FIG. 5, in another embodiment of the invention the insulation encasing step S6 is further preceded by a stretching step S61 to change total length of the conductive bus B by stretching via a fabrication process. More specifically, during implementation of the stretching step S61 the conductive bus B can be softened by heating in advance, then a stretching machinery is used to draw the conductive bus B to change the length thereof. During the stretching process of the conductive bus B the diameter size of each conductive strand A also is changed to become smaller. The stretching degree depends on requirement or ductility of the materials that form the conductive strand A. In addition, please referring to FIG. 6, the method of the invention also can include a calendering step S62 preceded the insulation encasing step S6 by applying a pressure on the conductive bus B through a mechanical fabrication process to flatten the conductive bus B (not shown in the drawings). The mechanical fabrication process can be implemented through a calendaring process to roll over the conductive bus B to change its profile. Moreover, the calendaring step S62 also can be carried out between the stretching step S61 and the insulation encasing step S6, namely after the stretching step S61 and before the insulation encasing step S6. Implementation is same as previously discussed, hence is omitted herein. Furthermore, please referring to FIG. 7, the manufacturing method of the invention can further include a cutting step S63 before or after the insulation encasing step S6 to cut the conductive bus B at a preset length, thereby the finished multi-core electric power metal conductive wire can be cut to different lengths according to length specifications to meet use requirements.

As a conclusion, the multi-core electric power metal conductive wire of the invention is manufactured according to the processes as follow: first, provide a plurality of solid conductive cores; next, provide a first conductive metal material with a first DC resistance to encase each conductive core to form a conductive strand, and bind the resulting conductive strands in a bundle; then, encase the conductive strands via at least one sheet type second conductive metal material to form a conductive bus with a connection seam formed at the not connecting portion to form an electric connection spot thereon through a welding process; finally, provide an insulation encasing material to encase the conductive bus to finish the multi-core electric power metal conductive wire. The multi-core electric power metal conductive wire thus formed includes conductive layers formed by encasing different conductors in a multi-layer fashion, hence can reduce the impact of skin effect on the conductive wire.

What is claimed is:

1. A method for manufacturing multi-core electric power metal conductive wires, comprising the steps of:
preparing material step: providing a plurality of solid conductive cores;
first encasing step: providing a first conductive metal material with a first DC resistance to encase each conductive core to form a conductive strand;
binding step: collecting and binding a plurality of conductive strands in one bundle;
second encasing step: providing at least one sheet type second conductive metal material to encase the bundle of the conductive strands to form a conductive bus and form a connection seam between two side walls of the second conductive metal material not yet connected, the second conductive metal material having a second DC resistance smaller than the first DC resistance;
electric connection step: forming an electric connection spot at the connection seam to bridge the two side walls of the second conductive metal material that face the connection seam through a welding process; and
insulation encasing step: providing an insulation encasing material to encase the conductive bus to finish the multi-core electric power metal conductive wire.

2. The method of claim 1, wherein the insulation encasing step is further preceded by a stretching step to change total length of the conductive bus by stretching via a fabrication process.

3. The method of claim 1, wherein the insulation encasing step further is preceded by a calendering step to apply a pressure on the conductive bus through a mechanical fabrication process to flatten the conductive bus.

4. The method of claim 2, wherein the stretching step and the insulation encasing step are interposed by a calendering step to apply a pressure on the conductive bus through a mechanical fabrication process to flatten the conductive bus.

5. The method of claim 1, wherein the insulation encasing step further is followed by a cutting step to cut the conductive bus at a preset length.

6. The method of claim 1, wherein the insulation encasing step further is preceded by a cutting step to cut the conductive bus at a preset length.

7. The method of claim 1, wherein the first DC resistance of the first conductive metal material is greater than the DC resistance of the conductive core.

8. The method of claim 1, wherein the conductive strands are woven in a cross-woven fashion in the one bundle at the binding step.

9. A multi-core electric power metal conductive wire fabricated according to the method of claim 1.
